(19) United States
(12) Patent Application Publication
(10) Pub. No.: US 2018/0357593 A9
(43) Pub. Date: Dec. 13, 2018

(54) METHOD FOR LEVELING DELIVERY COUNTS

(71) Applicant: Nippon Gas Co., LTD., Tokyo (JP)

(72) Inventors: Shinji Wada, Tokyo (JP); Shingo Dekamo, Tokyo (JP)

(21) Appl. No.: 15/838,277

(22) Filed: Dec. 11, 2017

Related U.S. Application Data
(63) Continuation of application No. 14/406,294, filed on Dec. 8, 2014, now abandoned.

(30) Foreign Application Priority Data
Jun. 8, 2012 (JP) 2012-130616

(51) Int. Cl. G06Q 10/08; G06Q 50/06; G06Q 50/28

(52) U.S. Cl. CPC G06Q 10/083; G06Q 50/06; G06Q 50/28

(57) ABSTRACT

The business of delivering LP gas cylinders involves the work of leveling scheduled delivery counts for a scheduled delivery day in a predetermined period based on delivery capabilities of deliverymen. However, it takes a lot of time because a delivery manager, a deliveryman or the like performs this work with direct data reference. The delivery management system causes to a computer to extract data from each data storage unit, calculate a total deliverable count that is the total of deliverable counts for each scheduled delivery day in the predetermined period, calculate a total scheduled delivery count, and calculate a leveled count for each scheduled delivery day in the predetermined period.

### TECHNICAL FIELD

The present invention relates to a method for leveling delivery counts. More specifically, the present invention relates to a method for coordinating a delivery due date by leveling the scheduled delivery count of liquefied petroleum (LP) gas cylinders by the deliverable count.

### BACKGROUND ART

Conventionally, LP gas is categorized into gas that is imported from producers of industrial gas, and gas that is domestically generated during the manufacturing of petrochemical products. Import stations that store the LP gas transported by tankers from the industrial gas producers and oil refinery stations are called the primary stations. The LP gas in the primary station is loaded into coastal vessels and tank trucks, and shipped to the secondary stations, which are transit stations located along or away from the coasts. Further, the LP gas carried to the secondary stations is transported to LP gas filling stations (delivery bases) in various regions, and is filled gas cylinders in the delivery bases.

The gas cylinders filled with the LP gas in the delivery bases are delivered by deliverymen to customers' homes, such as general houses, apartment buildings and offices. The empty gas cylinders at the customers' houses are replaced with filled gas cylinders, and the empty gas cylinders are collected at the delivery bases. Further, fixed delivery areas which the deliverymen are in charge of are allocated to each of the individual delivery bases. The deliverymen deliver the gas cylinders to the customers in the delivery areas based on delivery slips. The delivery slips are prepared by a delivery manager, and include the destinations of the customers to be delivered for each delivery due date.

The delivery due date is determined by predicting, the remaining amount of LP gas in a gas cylinder based on the records of the gas usage for each customer, the meter indication of a gas meter at the customer' s house, a delivery track record, etc. For example, Patent literature 1 discloses the technique, in order to reduce a probability for the occurrence of gas shortage in a gas cylinder, for determining a delivery due date by calculating the remaining amount of gas in the gas cylinder and the average gas usage for one day for each customer based on the meter indication and the delivery track record for each customer, predicting a gas shortage date based on the remaining amount and the average gas usage, subtracting, from the gas shortage date, the number of days for ensuring safety which is an arbitrary number of days obtained by taking a risk for gas shortage into account.

In this way, the delivery count (scheduled delivery count) of gas cylinders for each day is also determined for each delivery base by determining the delivery due date for each customer.

### CITATION LIST

### Patent Literature

PTL 1: Japanese Patent Laid-Open No. H08-329159 (1996)

However, while the scheduled delivery count for each day is determined for each delivery base, the delivery capacity, i.e., the deliverable count for one day actually differs depending on the delivery bases. The delivery capacity differs for the individual delivery bases because the number of customers and the gas usages are different for the delivery areas allocated for the individual delivery bases, and the working system for the deliverymen is prepared based on these factors. Furthermore, since the scheduled delivery count is greatly affected by the usage records of customers, the daily delivery count is not always the average count. For example, in an inefficient case, although the scheduled delivery count for a specific day is greater than the deliverable count, the scheduled delivery count for the following day is smaller. Therefore, the deliverable count is used to coordinate the scheduled delivery count and the delivery due date for a predetermined period (in the specification of this invention, the coordination process, including coordination of the scheduled delivery count and the coordination of the delivery due date, is called leveling). Specifically, delivery priorities are provided, and one part of the scheduled delivery count is reallocated, manually (by a delivery manager, for example) , for the preceding or succeeding day of the delivery due date that was determined in advance, so that the scheduled delivery count can fall within the deliverable count. This operation is performed for the delivery count on the delivery due date for a predetermined period (e.g., one week) later. A predetermined period is designated as a range of a period, based on the idea that, because of traffic conditions, etc., gas cylinders cannot be delivered according to the scheduled delivery count that has been leveled, or the number of gas cylinders to be newly delivered is varied on a daily basis, and therefore, when leveling is performed while taking into account the delivery count for the distant future, leveling must be performed again when a predetermined period elapses.

Further, the deliverable count for a day is different even in one delivery base. This is because the deliverable count for one day is the total of the deliverable counts assigned for the deliverymen who work at the same delivery base, but the deliverable counts for the deliverymen are different depending on the capabilities of the deliverymen, and also, the deliverymen who work are different every day.

Moreover, for leveling the delivery count, there are customers and gas cylinders that are excluded from the leveling. An example for this is a case wherein the day of a week or the schedule of the day is designated by a customer and the change of the delivery due date is not allowed. In such a case, the number of gas cylinders related to this case is regarded as an exception count, and is subtracted in advance from the deliverable count (i.e., the number of these gas cylinders is allocated to the deliverable count), and thereafter, leveling is performed.

The delivery manager, the deliveryman, etc., perform the above described leveling operation by directly examining data, and must spend very much time and effort on this job. Further, as described above, since there is also a case wherein, due to the traffic conditions, delivery cannot be performed according to the delivery count that has been leveled, or a case wherein new delivery of gas cylinders is required on a daily basis, a period during which the scheduled delivery count that has been leveled is usable is not very long, and the leveling operation must be performed periodically.

While taking the above described problems into account, the objective of the present invention is to cause a computer to perform a method for coordinating the delivery due date that is determined in advance by leveling, using the deliverable count, the scheduled delivery count of LP gas cylinders in a predetermined period.

### SUMMARY OF INVENTION

To achieve this objective, according to a first aspect of the present invention, a method, for leveling scheduled delivery count in a predetermined period based on delivery capabilities of deliverymen in a system that includes a deliveryman data storage unit for storing, at least, identification data for the deliverymen and cylinder counts of gas cylinders deliverable by the deliverymen in one day, a delivery schedule data storage unit for storing, at least, a delivery due data and scheduled delivery count, and a leave data storage unit for storing leave data for the deliverymen, comprising:

a data acquisition unit of the system extracting, from the delivery schedule data storage unit, delivery schedule data of delivery due dates in the predetermined period;

the data acquisition unit extracting data for deliverymen from the deliveryman data storage unit,

the data acquisition unit extracting, from the leave data storage unit, leave data for the deliverymen whose data have been extracted;

a deliverable count calculation unit of the system adding up, based on the extracted leave data and for each delivery due date, the cylinder counts of gas cylinders deliverable in one day for deliverymen who are not day off on the delivery due dates in the predetermined period to obtain deliverable count for each delivery due date in the predetermined period;

the deliverable count calculation unit adding up the deliverable counts for each delivery due date in the predetermined period to obtain total deliverable count;

a scheduled delivery count calculation unit of the system adding up scheduled delivery counts of the extracted delivery schedule data to obtain total scheduled delivery count; and

a leveled count calculation unit of the system calculating leveled count for each delivery due date in the predetermined period in accordance with a first expression

(deliverable count for each delivery due date/total deliverable count)*total scheduled delivery count.

Further, the method is characterized in that:

the system described in the preceding paragraph includes a leveling exception data storage unit for storing objects to be excluded from a leveling process, and wherein the method further comprises:

the data acquisition unit extracting leveling exception data from the leveling exception data storage unit; and

a leveling exception count calculation unit of the system adding together, based on the leveling exception data that has been extracted and for each of the delivery due dates, scheduled delivery counts that are not covered by the leveling process, and obtaining the leveling exception count for each day in the predetermined period,

and wherein the calculating the leveled count includes a calculating leveled count for each delivery due date in the predetermined period in accordance with a second expression

((deliverable count for each delivery due date/total deliverable count)*total scheduled delivery count)−leveling exception count for each delivery due date.

Moreover, the method is characterized in that:

the delivery schedule data storage unit further stores delivery intervals that are risk coefficients for gas shortage of the gas cylinders, and wherein the method further comprises:

the data acquisition unit sorting the extracted delivery schedule data based on the delivery due dates and the delivery intervals;

a delivery schedule assignment unit of the system adding up, for each delivery due date, scheduled delivery counts of the extracted delivery schedule data to obtain scheduled delivery count for each delivery due date in the predetermined period; and

the delivery schedule assignment unit coordinating delivery due dates of the delivery schedule data in order beginning at the first delivery due date in the predetermined period, the coordinating including:
comparing, for the first delivery due date, an scheduled assignment count with a leveled count for each delivery due date;
when the compared scheduled assignment count is greater than the compared leveled count, updating a delivery due date for surplus to the following day; and
when the compared leveled count is greater than compared scheduled assignment count, updating delivery due date for difference between compared leveled count and compared scheduled assignment count, to be delivered in the following day, to the day before the following day, and of repeating the coordinating for each delivery due date in the predetermined period until the last delivery due date.

As described above, according to the present invention, the delivery due date determined in advance can be coordinated by leveling the scheduled delivery count of the LP gas cylinders in a predetermined period while taking into account the delivery for which the delivery due date cannot be altered.

### BRIEF DESCRIPTION OF DRAWINGS

FIG. 1 is a diagram illustrating a network configuration according to one embodiment of the present invention;

FIG. 2 is a block diagram illustrating the configuration of a delivery server according to the embodiment of the present invention;

FIG. 3 is a diagram showing example data stored in a delivery schedule data storage unit according to the embodiment of the present invention;

FIG. 4 is a diagram showing example data stored in deliveryman data storage unit according to the embodiment of the present invention;

FIG. 5 is a diagram showing example data stored in a leave data storage unit according to the embodiment of the present invention;

FIG. 6 is a diagram showing example data, different from FIG. 5, stored in the leave data storage unit according to the embodiment of the present invention;

FIG. 7 is a diagram showing example data stored in a leveling exception data storage unit according to the embodiment of the present invention;

FIG. 8 is a diagram showing the structure for FIGS. 8A to 8C;

FIG. 8A is a flowchart showing the leveled count calculation processing according to the embodiment of the present invention;

FIG. 8B is a flowchart showing the leveled count calculation processing according to the embodiment of the present invention;

FIG. 8C is a flowchart showing the leveled count calculation processing according to the embodiment of the present invention;

FIG. 9 is a diagram illustrating example deliverable count data according to the embodiment of the present invention;

FIG. 10 is a diagram showing example scheduled delivery count data according to the embodiment of the present invention;

FIG. 11 is a diagram showing example leveled count (intermediate) data according to the embodiment of the present invention;

FIG. 12 is a diagram showing example leveling exception data according to the embodiment of the present invention;

FIG. 13 is a diagram showing example leveled count data according to the embodiment of the present invention.

FIG. 14 is a diagram showing the structure for FIGS. 14A to 14C;

FIG. 14A is a flowchart showing the delivery schedule assignment processing according to the embodiment of the present invention;

FIG. 14B is a flowchart showing the delivery schedule assignment processing according to the embodiment of the present invention; and

FIG. 14C is a flowchart showing the delivery schedule assignment processing according to the embodiment of the present invention.

### DESCRIPTION OF EMBODIMENTS

A delivery system according to one embodiment of the present invention will now be described in detail, while referring to the accompanying drawings.

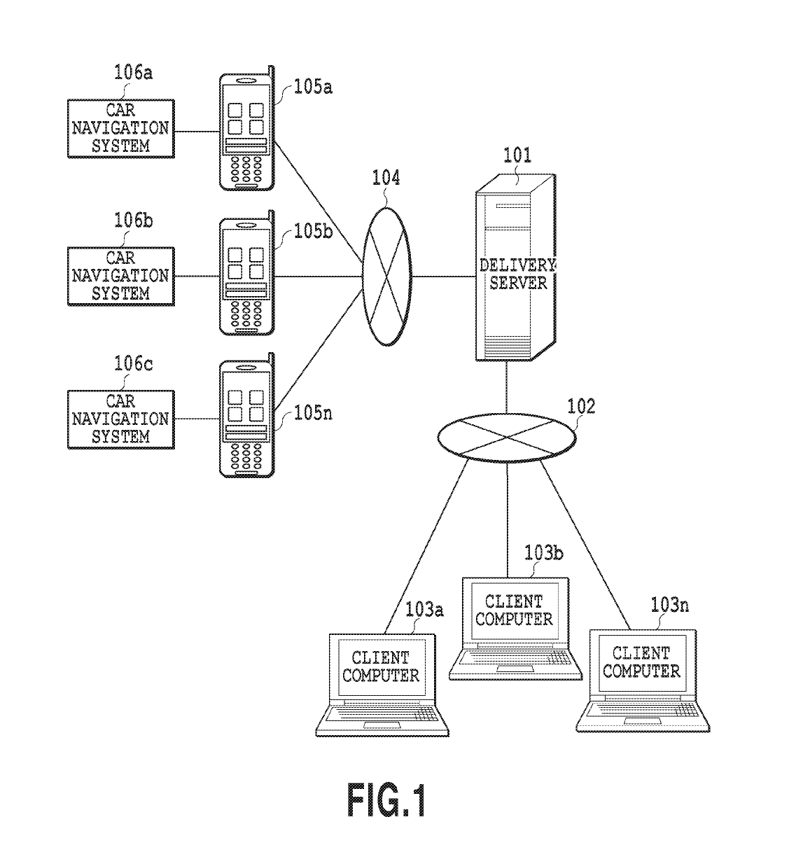

First, the overview of a gas cylinder delivery system will be described. FIG. 1 is a diagram illustrating a network configuration according to the embodiment of the present invention. In FIG. 1, a delivery server 101 installed in the main office, etc., is configured to perform communication via a network 102 with a plurality of client computers 103a, 103b, . . . and 103n (hereinafter, referred to as client computers 103) installed in a delivery center that performs unitary management of delivery for the individual delivery bases. The delivery server 101 is also configured to perform communication via a network 104 with a plurality of mobile terminals 105a, 105b, . . . , and 105n (hereinafter referred to as mobile terminals 105). Further, the mobile terminals 105 are configured to perform communication, by a short-range wireless communication technology (for example, Bluetooth (registered trademark)), with a plurality of car navigation systems 106a, 106b, . . . , and 106n (hereinafter referred to as car navigation systems 106) mounted on delivery trucks.

The delivery server 101 adds together data for gas cylinders that should be delivered on the following day and data for gas cylinders that should have been delivered on the current day, but could not be delivered to generate delivery schedule data for each delivery base. Thereafter, the delivery server 101 assigns the generated delivery schedule data to the individual deliverymen who work at the delivery base, and generates delivery schedule data per deliveryman.

Further, in response to a request for delivery schedule data from the mobile terminal 105 of a deliveryman, the delivery server 101 transmits, via the network 104, the delivery schedule data per deliveryman that corresponds to the requesting deliveryman. Moreover, the delivery server 101 receives, from the mobile terminal 105, delivery operation data, or undelivered task data for the deliveryman, and uses the received data to update the storage units of the delivery server 101.

The client computer 103 is a terminal used by a user at the delivery center. The user accesses the delivery server 101 via the client computer 103, and performs a delivery operation, such as confirmation of a delivery condition and an instruction for creating delivery schedule data. In this embodiment, the client computer 103 is installed in the delivery center; however, as well as the delivery server 101, the client computer 103 may also be installed in the head office or the delivery base.

The mobile terminal 105 is a terminal carried by each deliveryman at the delivery base. The deliveryman accesses the delivery server 101 via the mobile terminal 105, and transmits a request for delivery schedule data. When the delivery schedule data is received, the deliveryman uses the mobile terminal 105 to transmit, to the car navigation system 106, address data for customers (postal codes, addresses, latitude/longitude information, etc.) that are included in the delivery schedule data.

The car navigation system 106 is mounted on the delivery truck and is used by the deliveryman. When the car navigation system 106 receives address data from the mobile terminal 105, the car navigation system 106 can use the address data for identifying a plurality of corresponding locations, and as delivery support data for the deliverymen.

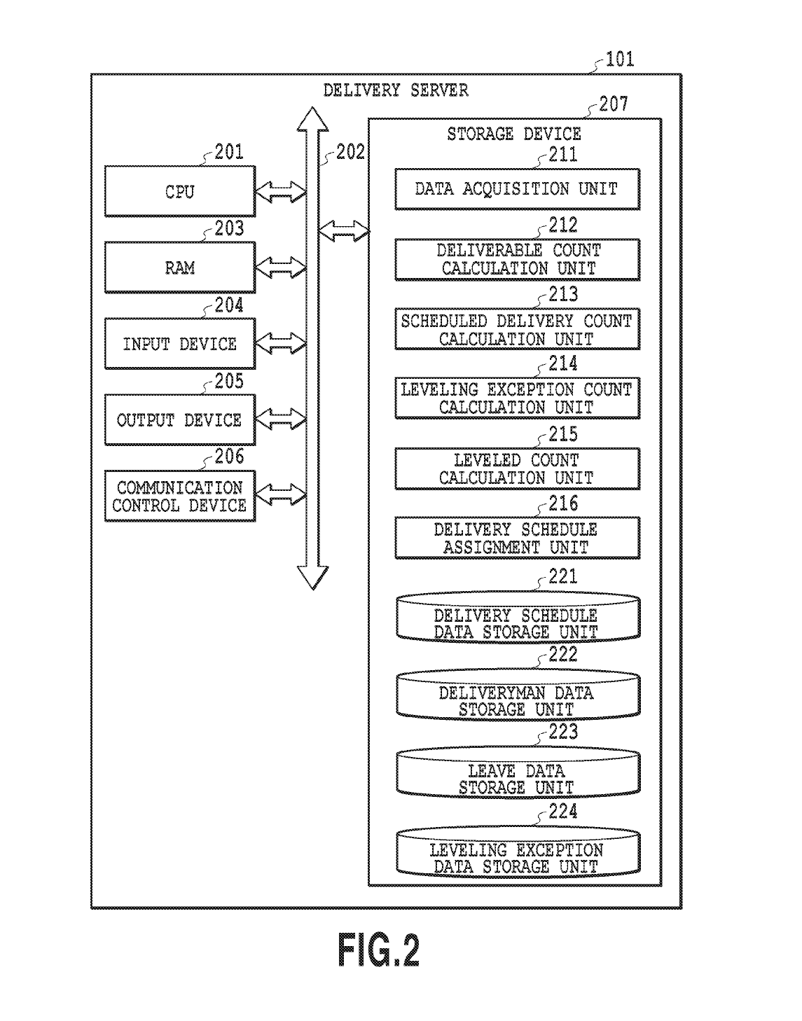

The above described configuration of the delivery server 101 will now be described in detail, while referring to the block diagram in FIG. 2. Referring to FIG. 2, only necessary functions are illustrated on the assumption of the usage of a single computer system; however, the delivery server 101 may also be provided as one part of a distributed multi-function system that includes a plurality of computer systems.

The delivery server 101 has an configuration where a RAM 203, an input device 204, an output device 205, a communication control device 206 and a storage device 207 that includes a nonvolatile storage medium (a ROM, an HDD, etc.) are coupled to a CPU 201 via a system bus 202. The storage device 207 includes a program storage area to store a software program, for performing the individual functions of the delivery system, and a data storage area to store, for example, data acquired as needed and data indicating the processing results. The individual units in the program storage area to be explained below are actually independent software programs and the routines or components thereof. The individual units perform the corresponding functions by being retrieved from the storage device 207 by the CPU 201, developed in the work area of the RAM 203, and being sequentially executed while properly referring to a database, etc.

The data storage area includes a delivery schedule data storage unit 221, a deliveryman data storage unit 222, a leave data storage unit 223 and a leveling exception data storage unit 224. All of these storage units are predetermined storage areas reserved in the storage medium 207.

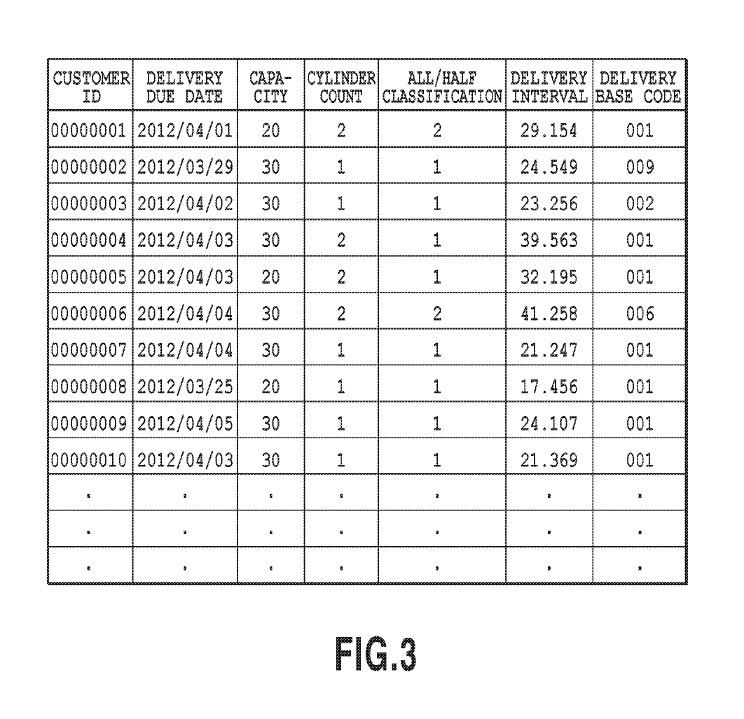

The delivery schedule data storage unit 221 is used to store information for a delivery schedule, such as a delivery due date and a cylinder count to be delivered. In this embodiment, as shown in FIG. 3, a “customer ID” to identify a customer, a “delivery due date”, a “capacity” indicating the capacity of a gas cylinder to be delivered, a “cylinder count” indicating the scheduled number of gas cylinders to be delivered, a “delivery interval” indicating a risk factor for gas shortage, which will be described later in detail, and a “delivery base code” to identify a delivery base at which a deliveryman works, are stored in the delivery schedule data storage unit 221.

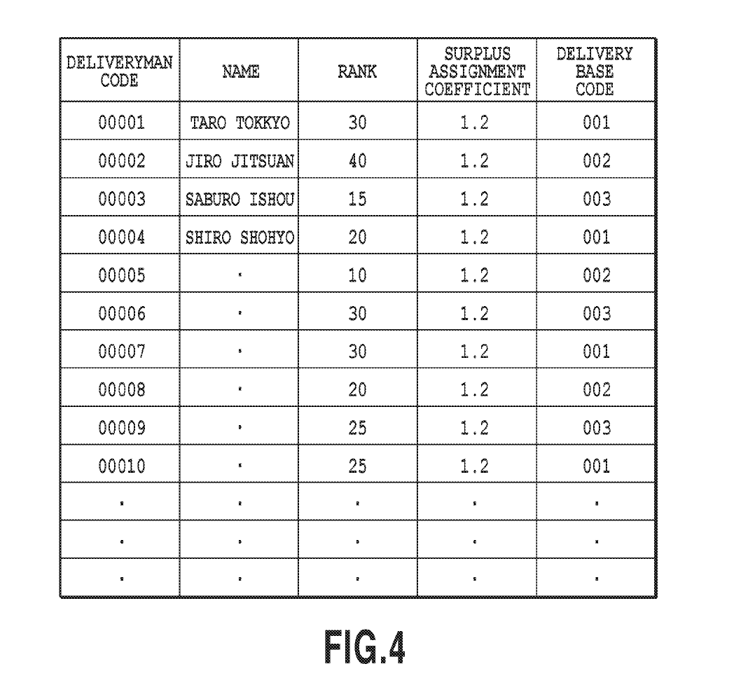

The deliveryman data storage unit 222 is used to store information for a deliveryman, such as the name of the deliveryman and a delivery base where the deliveryman works. In this embodiment, as shown in FIG. 4, a “deliveryman code” to identify a deliveryman, a “name” indicating the name of the deliveryman, a “rank” representing the delivery capability of the deliveryman, a “surplus assignment coefficient” that is a coefficient to calculate the number of cylinders can be assigned in excess of the delivery capability, and a delivery base code are stored in the deliveryman data storage unit 222. Especially in this embodiment, the number of gas cylinders the deliveryman can deliver in a day can be set to the “rank”. In this case, when the “surplus assignment coefficient” is multiplied by the “rank”, the number of cylinders that includes the number can be assigned in excess of the delivery capability can be obtained.

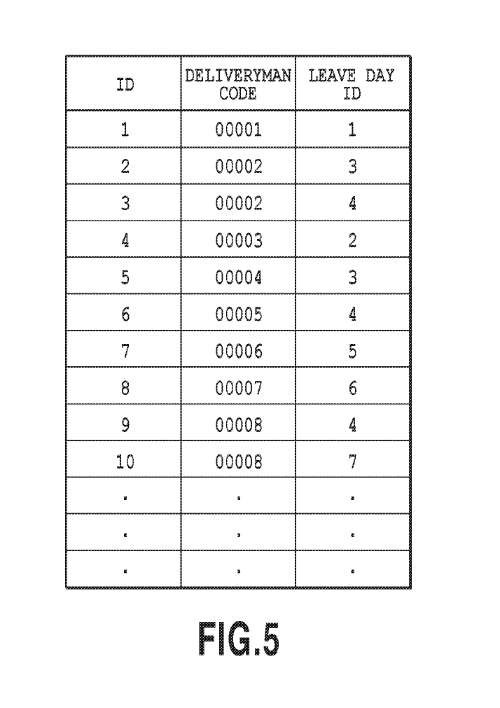

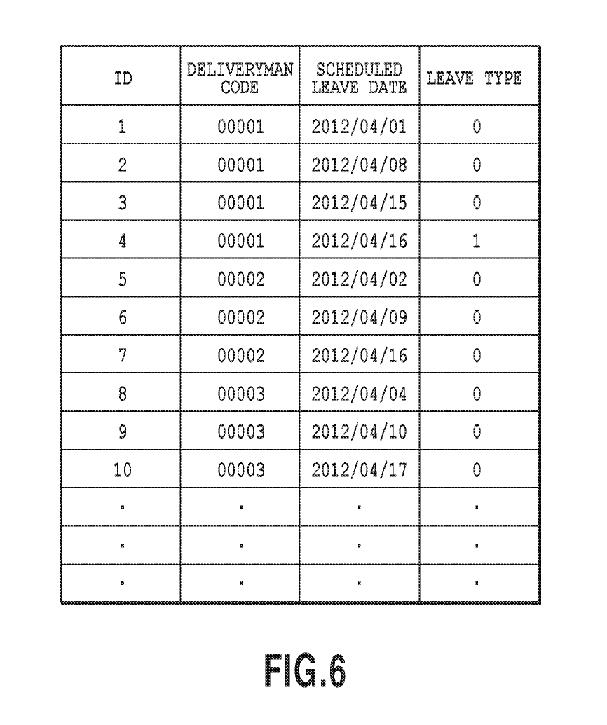

The leave data storage unit 223 is used to store information about a leave for a deliveryman, such as a day off for the deliveryman. In this embodiment, as shown in FIG. 5, an “ID” that is a unique value, a “deliveryman code”, and a “leave day ID” representing the fixed leave for the deliveryman are stored in the leave data storage unit 223. Especially in this embodiment, the “leave day ID” can be set by allocating a specified number to each day of a week, such as “1” for Sunday and “2” for Monday. Further, another embodiment is shown in FIG. 6, and an “ID” that is a unique value, a “deliveryman code”, an “scheduled leave date” and a “leave type” indicating the type of leave, such as a one-day leave or a half-day leave, are stored. Especially in this embodiment, the “leave type” can be set by using “0” for a one-day leave or “1” for a half-day leave. The example in FIG. 6 is provided as another embodiment; however, leave data shown in both FIGS. 5 and 6 may also be employed.

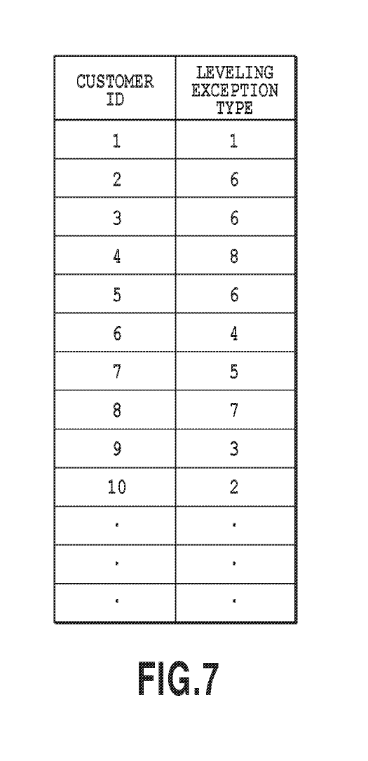

The leveling exception data storage unit 224 is used to store information for a leveling exception object, such as a customer who is excluded from the leveling processing. In this embodiment, as shown in FIG. 7, a “customer ID” and a “leveling exception type”, indicating the type of reason for the exception from the leveling processing, are stored in the leveling exception data storage unit 224. The reason for the exception from the leveling processing is, for example, a case wherein a date is designated by a customer, a case wherein delivery is required every day because a customer runs a restaurant, or a case wherein prompt delivery is required due to the occurrence of gas shortage. In such a case, since it is not appropriate that the delivery due date determined in advance be coordinated by performing the leveling processing, this case is excluded from the leveling processing. The leveling exception data in FIG. 7 is merely an example, and data may be managed and stored for each exception reason.

The software program stored in the program storage area includes a data acquisition unit 211, a deliverable count calculation unit 212, a scheduled delivery count calculation unit 213, a leveling exception count calculation unit 214, a leveled count calculation unit 215 and a delivery schedule assignment unit 216

The data acquisition unit 211 acquires predetermined data from the storage units of the data storage area. The data acquisition unit 211 first extracts, from the delivery schedule data storage unit 211, delivery schedule data for one delivery base and delivery due dates in a predetermined period (for example, one week from now on). Then, the deliveryman data for one delivery base is extracted from the delivery schedule data storage unit 222. When the deliveryman data is extracted, the data acquisition unit 211 extracts leave data from the leave data storage unit 223. Further, when the delivery schedule data has been extracted, the data acquisition unit 211 extracts leveling exception data in the predetermined period from the leveling exception data storage unit 224. Moreover, when the delivery schedule data is extracted, or has been extracted, the data acquisition unit 211 sorts the delivery schedule data in a predetermined order.

The deliverable count calculation unit 212 adds up the ranks of the extracted deliveryman data to calculate the deliverable count for each day in the predetermined period, while taking the leave data into account. Furthermore, the deliverable count calculation unit 212 adds up the deliverable counts for the individual days to obtain the total of deliverable counts in the predetermined period (hereinafter referred to as total deliverable count).

The scheduled delivery count calculation unit 213 adds up the (delivery scheduled) count of the extracted delivery schedule data to obtain the total of the scheduled delivery counts in the predetermined period (hereinafter referred to as total scheduled delivery count).

The leveling exception count calculation unit 214 calculates the leveling exception count for each day in the predetermined period, based on the extracted delivery schedule data and the extracted leveling exception data.

The leveled count calculation unit 215 calculates intermediate data for the leveled count for each day in the predetermined period (hereinafter referred to as leveled count (intermediate)), based on the deliverable count for a day, the total deliverable count and the total scheduled delivery count that have been obtained. The leveled count (intermediate) is the cylinder count at the stage at which the leveling exception count is not yet considered, and is regarded as intermediate data in this specification in order to be distinguished from the final leveled count. Further, the leveled count calculation unit 215 calculates the final data for the leveled count (hereinafter referred to as the leveled count) based on the obtained leveled count (intermediate) and the leveling exception count for each day.

The delivery schedule assignment unit 216 adds up the scheduled delivery counts for the individual delivery due dates based on the extracted delivery schedule data. Further, the delivery schedule assignment unit 216 subtracts the leveled count for a day from the total scheduled delivery count to obtain the scheduled assignment count for a day. The delivery schedule assignment unit 216 also compares the scheduled assignment count for each day with the leveled count for each day to assign delivery schedule data.

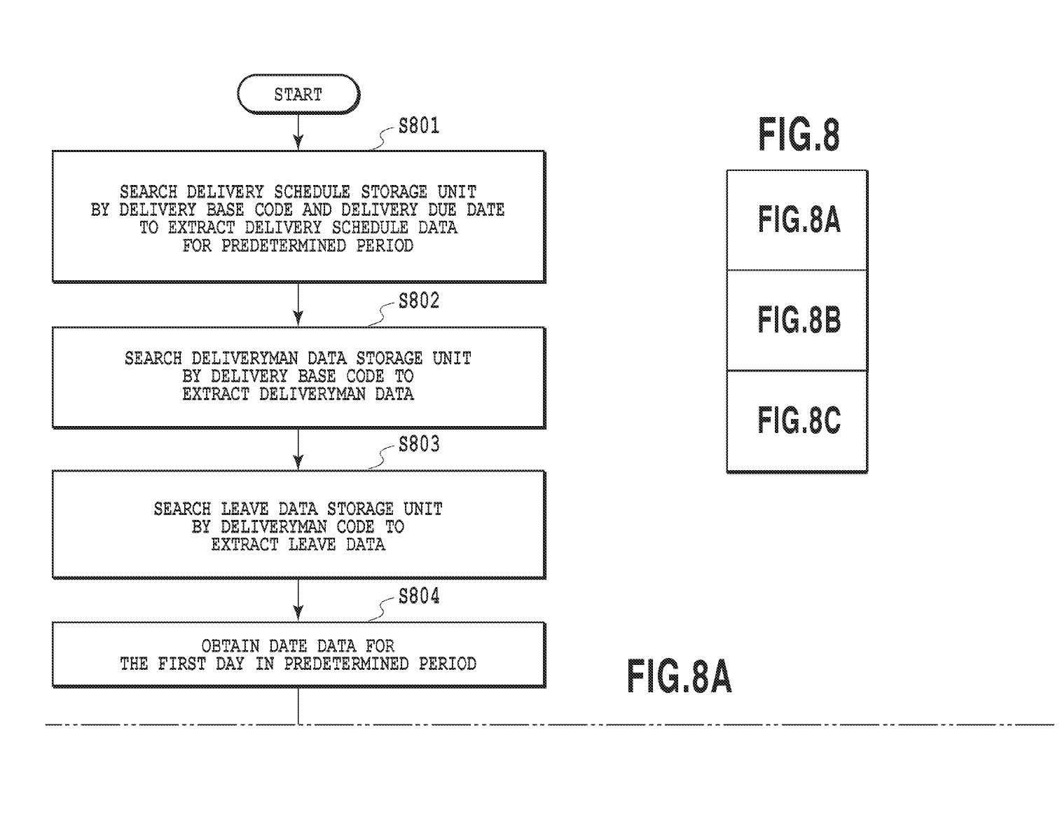

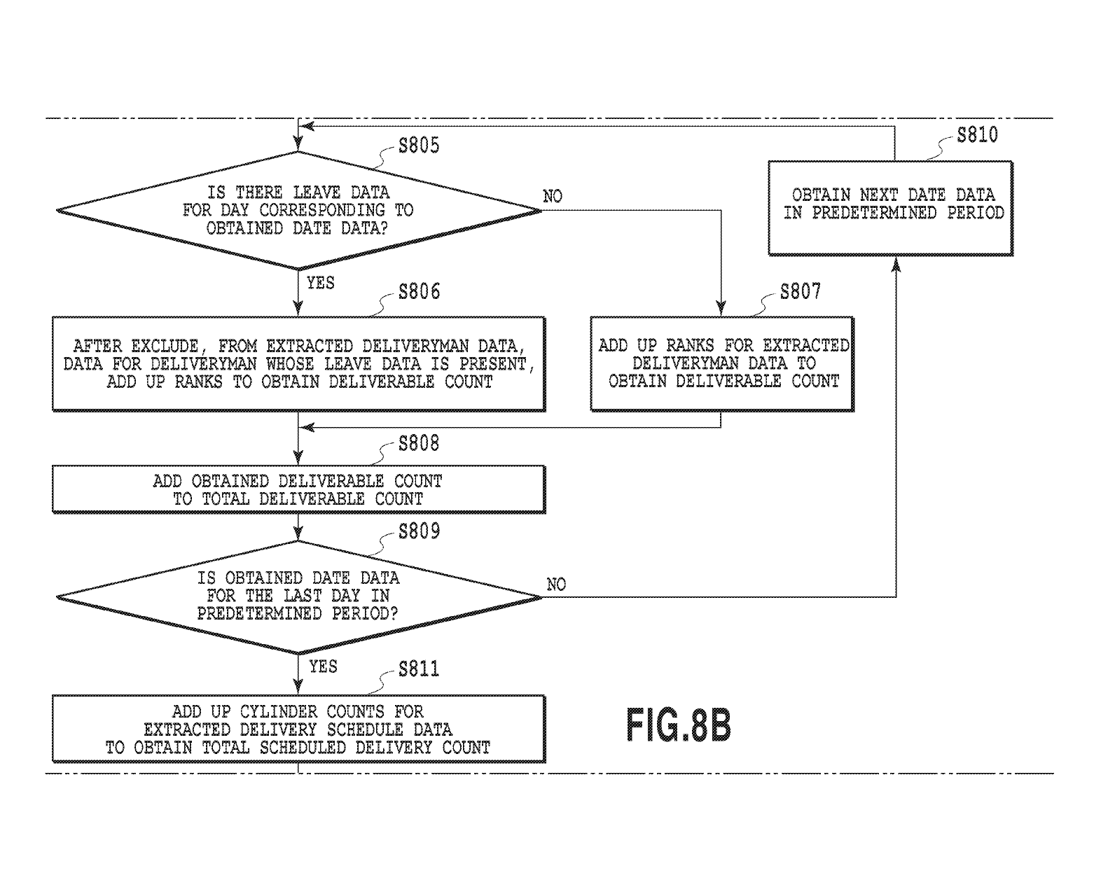

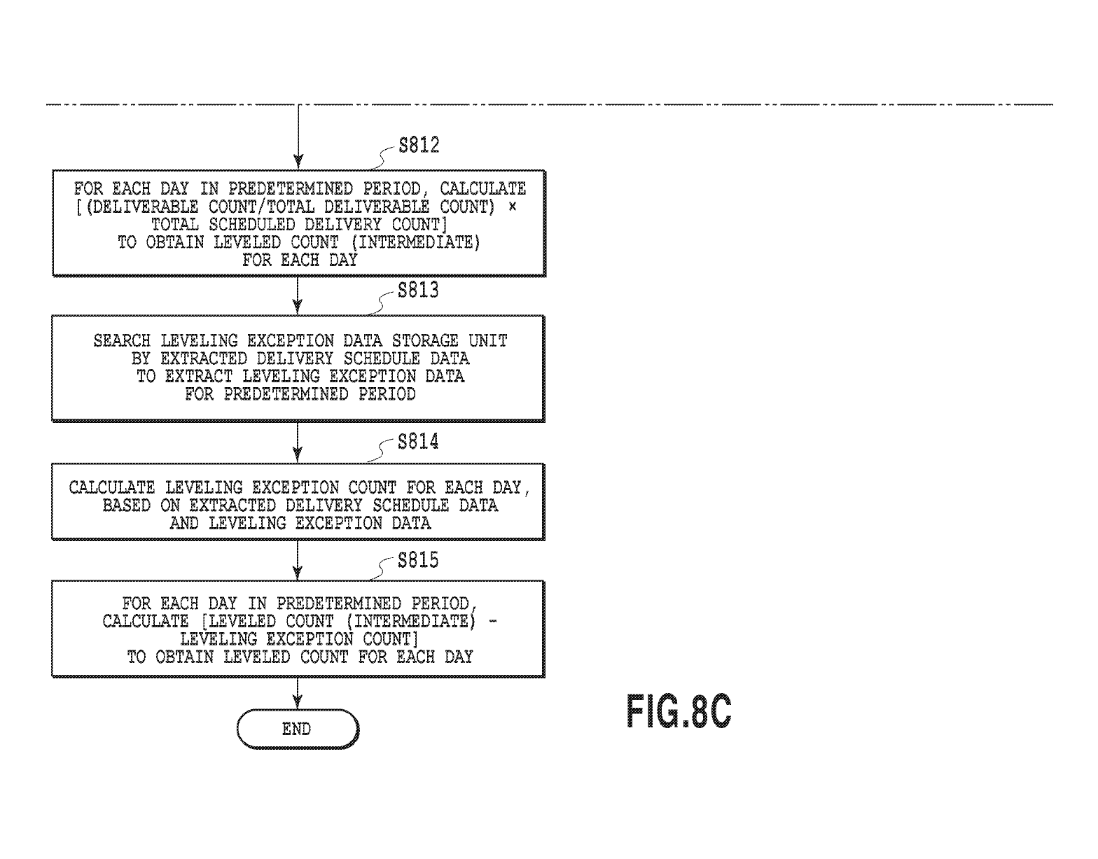

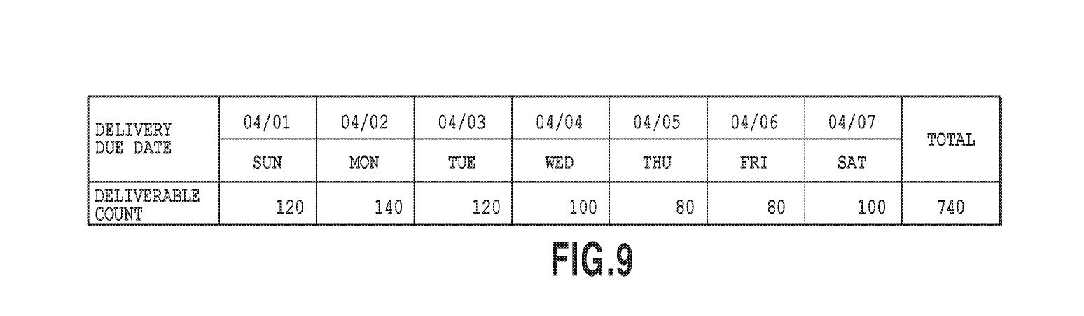

Next, the leveled count calculation processing according to the embodiment will be described in detail, while referring to the flowcharts in FIGS. 8A to 8C and the tables in FIGS. 9 to 13.

First, the data acquisition unit 211 extracts, from the delivery schedule data stored in the delivery schedule data storage unit 221 (FIG. 3), delivery schedule data that is correlated with the delivery base code of a specific delivery base for which the leveling processing is to be performed, and that represents the delivery due date falling within a predetermined period (step 801). Here, the predetermined period is a period applicable for the leveling processing, and is, for example, one week from the following day of the processing date. As another embodiment, this period may be designated as one week from two days after the processing date, or instead of setting this period, all of the delivery schedule data for a specific delivery base may be employed as the processing subjects.

Following this, the data acquisition unit 211 extracts, from the deliveryman data stored in the deliveryman data storage unit 222 (FIG. 4), deliveryman data that is correlated with the delivery base code of the specific delivery base, for which the leveling processing is to be performed (step 802). It should be noted that either process, step 801 or step 802, may be performed first.

Subsequently, the data acquisition unit 211 extracts, from leave data stored in the leave data storage unit 223 (FIG. 5 and/or FIG. 6), leave data that is correlated with the delivery code of the deliveryman data extracted at step 802 (step 803). The leave (absence) data in FIG. 5 is example data in a case wherein the leaves for the deliverymen are fixed on the days of a week. The leave data in FIG. 6 is example data in a case wherein the leaves for the deliverymen are designated according to the dates. Either one, or both of the leave data in FIGS. 5 and 6 can be employed. A case wherein both of the leave data in FIGS. 5 and 6 are employed is a case wherein, for example, the leaves of the deliverymen are fixed according to the days of a week, and an unscheduled day off is set. The leave type (“0”: all-day off, “1”: half-day off) of leave data in FIG. 6 can be employed for calculating the deliverable count, as will be described later in detail.

Following this, in order to calculate the deliverable count for each day in the predetermined period, and to calculate the total deliverable count that is the sum of the deliverable counts, the deliverable count calculation unit 212 obtains date data for the first day in the predetermined period , (step 804), and determines whether leave data for the same date as the first day in the predetermined period is included in the leave data that is extracted at step 803 (step 805). In a case wherein the leave data is included, the rank (deliverable count) of the deliveryman whose leave data is included (i.e., the deliveryman who takes a leave on the first day in the predetermined period) cannot be included in the deliverable count for the delivery base, and therefore, the deliverable count calculation unit 212 adds up the ranks in the deliveryman data extracted at step 802, excluding the deliveryman data for the deliveryman whose leave data is present to obtain the deliverable count of the specific delivery base for the first day in the predetermined period (step 806). In a case wherein, for example, the leave type of the leave data represents a half-day off, half the number of the rank may be added to obtain the total of the ranks.

In a case wherein leave data is not included at step 805 (i.e., a case wherein there are no deliverymen who take a leave on the first day in the predetermined period), the deliverable count calculation unit 212 adds the ranks of all of the deliveryman data extracted at step S802 to obtain the deliverable count for the specific delivery base for the first day in the predetermined period (step 807).

Subsequently, the deliverable count calculation unit 212 adds, to the total deliverable count (initial value of 0), the deliverable count obtained at step 806 or 807 (step 808). Then, the deliverable count calculation unit 212 determines whether the obtained date data (data for the nearest date, on which calculation for the deliverable count was performed) is the last date in the predetermined period (step 809). In a case wherein the nearest date is not the last day (i.e., a case wherein there are still more data to be processed), the deliverable count calculation unit 212 obtains data for the next day in the predetermined period (step 810), and repeats the processing from step 805 to step 809 for the data up to the last day in the predetermined period. As a result, the total deliverable count obtained at step 808 represents a total value of the deliverable counts for all of the days in the predetermined period. It should be noted that the total deliverable count can be obtained simply by adding up the deliverable counts of all the days in the predetermined period, and it is easily understood that the adding up processing needs not be performed in order beginning from the first day to the last day, as described above.

When the processing from step 801 to step 810 is performed in the above described manner, the deliverable count data shown as an example in FIG. 9 is obtained. The table in FIG. 9 shows the deliverable count for each delivery due date in the predetermined period (one week from April 1st to April 7th) and the total of the deliverable counts (=total deliverable count).

In a case wherein the obtained date data is the last day in the predetermined period at step 809, the scheduled delivery count calculation unit 213 adds up the (delivery scheduled) cylinder counts of the delivery schedule data extracted at step 801 to obtain the total scheduled delivery count in the predetermined period (step 811). It should be noted that, so long as the delivery schedule data has been extracted at step 801, the processing at step 811 can be performed at an arbitrary time before step 811 (e.g., between steps 801 and 802).

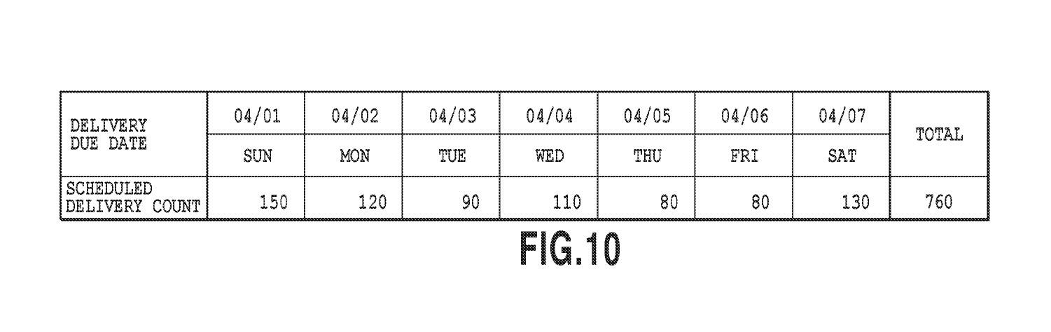

When the processing at step 811 is performed in the above described manner, the scheduled delivery count data shown as an example in FIG. 10 is obtained. The table in FIG. 10, as well as that in FIG. 9, shows the scheduled delivery count for each delivery due date in the predetermined period and the total of the scheduled delivery counts (=total scheduled delivery count).

Next, the leveled count calculation unit 215 calculates the leveled count (intermediate) for each day in the predetermined period (step 812). For this calculation, the following equation 1 is employed.

(deliverable count/total deliverable count)*total scheduled delivery count Equation 1

The deliverable count in equation 1 is deliverable count that is obtained at step 806 or 807 for an arbitrary day in the predetermined period. That is, equation 1 represents that leveling of the scheduled delivery count is performed by multiplying the total scheduled delivery count by the ratio of the deliverable count of the arbitrary day for the predetermined period. Further, equation 1 is calculated by rounding up the decimal part to the next whole number. This is to prevent a situation in which the total of the leveled counts (intermediate) for the individual days is less than the total scheduled delivery count.

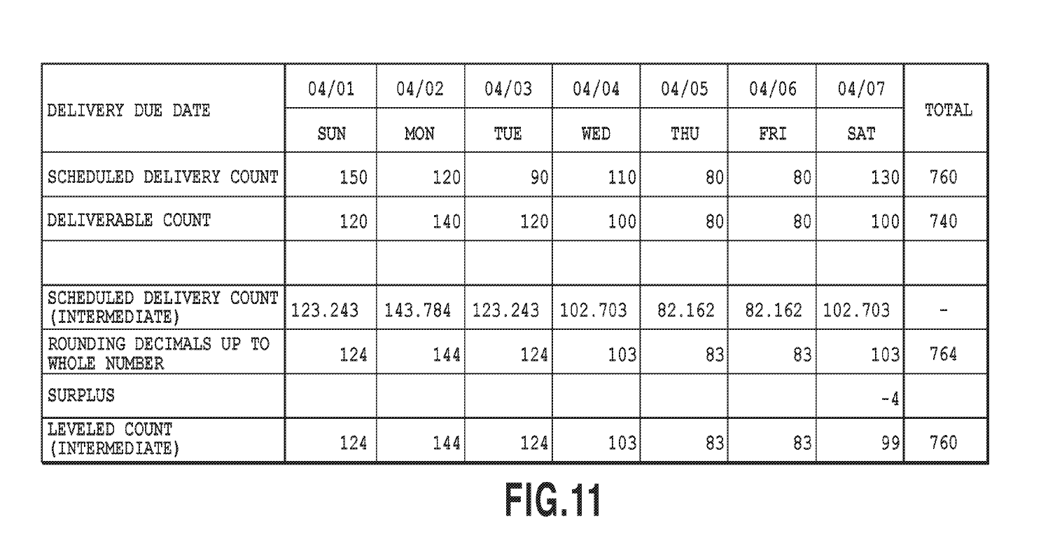

When the processing at step 812 is performed in the above described manner, the leveled count (intermediate) data shown as an example in FIG. 11 is obtained. The table in FIG. 11 shows the leveled count (intermediate) for each delivery due date in the predetermined period, and the total of the leveled counts (intermediate). It should be noted that, in order to precisely provide the progress of a calculation, in FIG. 11, the calculation result of equation 1 is represented as Scheduled Delivery Count (intermediate), and the result obtained by rounding up the decimal part of Scheduled Delivery Count (intermediate) to the next whole number is represented as Rounding Decimals Up To Whole Number. In a case wherein rounding up the decimal part of Scheduled Delivery Count (intermediate) is performed, there is a case wherein the total (764 cylinders in FIG. 11) of the leveled counts (intermediate) for the individual days is beyond the total scheduled delivery count (760 cylinders). In order to correct the total of the leveled counts (intermediate), the surplus (4 cylinders) is subtracted from the volume obtained for the last day in the predetermined period by rounding up the decimal part of Scheduled Delivery Count (intermediate) (−4 cylinders). As a result, the total of the leveled counts (intermediate) is corrected so as to be equal to the total scheduled delivery count. It should be noted that subtracting the surplus for the last day in the predetermined period is based on the idea that the deliverable gas cylinders should be delivered as early as possible; however, subtracting can also be performed on average in the predetermined period, or can be performed for the day, for which the leveled count (intermediate) most largely exceeds the deliverable count.

Following this, the data acquisition unit 211 extracts, from the leveling exception data (FIG. 7) stored in the leveling exception data storage unit 224, the leveling exception data that is correlated with the customer IDs of the delivery schedule data extracted at step 801 (step 813). The leveling exception count calculation unit 214 obtains the leveling exception count for each day in the predetermined period (step 814) by adding up, for each delivery due date of the delivery schedule data extracted at step 801, the (delivery scheduled) cylinder counts for the delivery schedule data that are correlated with the customer IDs of the leveling exception data extracted at step 813. It should be noted that, so long as the delivery schedule data has been extracted at step 801, the processing at steps 813 and 814 can be performed at an arbitrary time before step 813 (e.g., between steps 801 and 802).

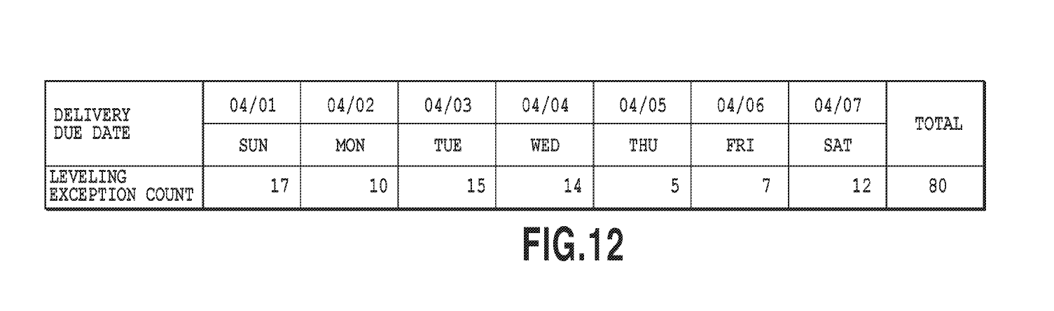

When the processing at steps 813 and 814 are performed in the above described manner, the leveling exception data shown as an example in FIG. 12 is obtained. The table in FIG. 12 represents the leveling exception count for each delivery due date in the predetermined period and the total of the leveling exception counts.

Subsequently, the leveled count calculation unit 215 calculates the leveled count for each day in the predetermined period (step 815). For this calculation, equation 2 below is employed.

Leveled count (intermediate)−leveling exception count Equation 2

The leveled count (intermediate) at equation 2 is the leveled count (intermediate) that is obtained at step 812 for an arbitrary day in the predetermined period. Similarly, the leveling exception count is the leveling exception count obtained at step 814.

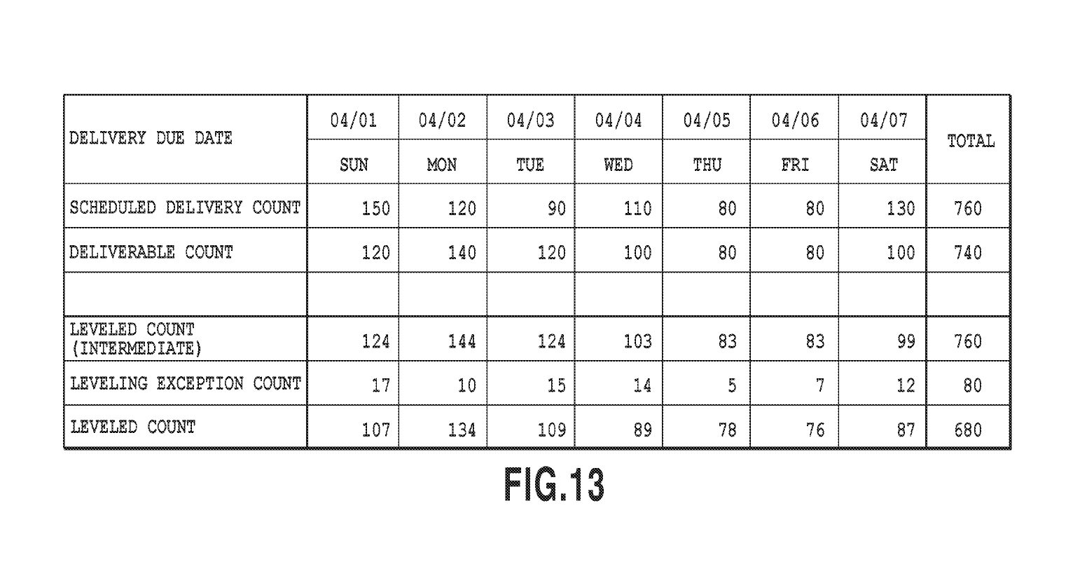

When the processing at step 815 is performed in the above described manner, the leveled count data shown as an example in FIG. 13 is obtained. The table in FIG. 13 shows the leveled count for each delivery due date in the predetermined period and the total of the leveled counts. After the processing at step 815 has been performed, the leveling processing is terminated.

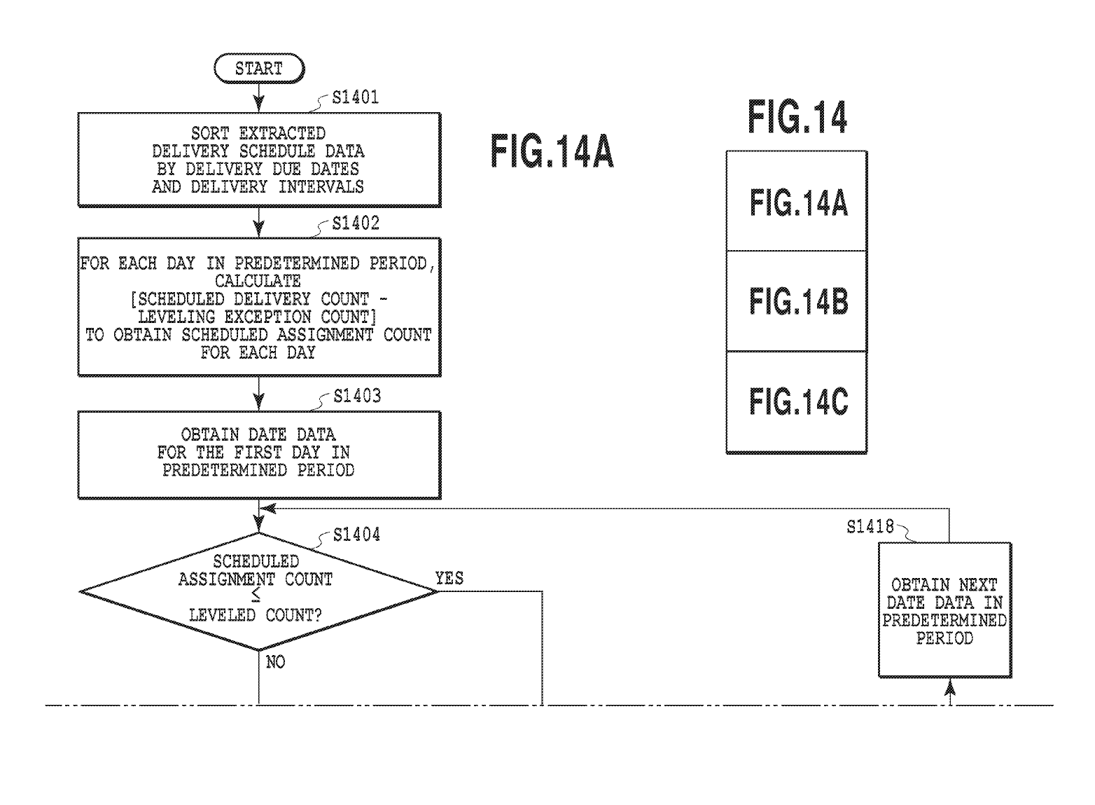

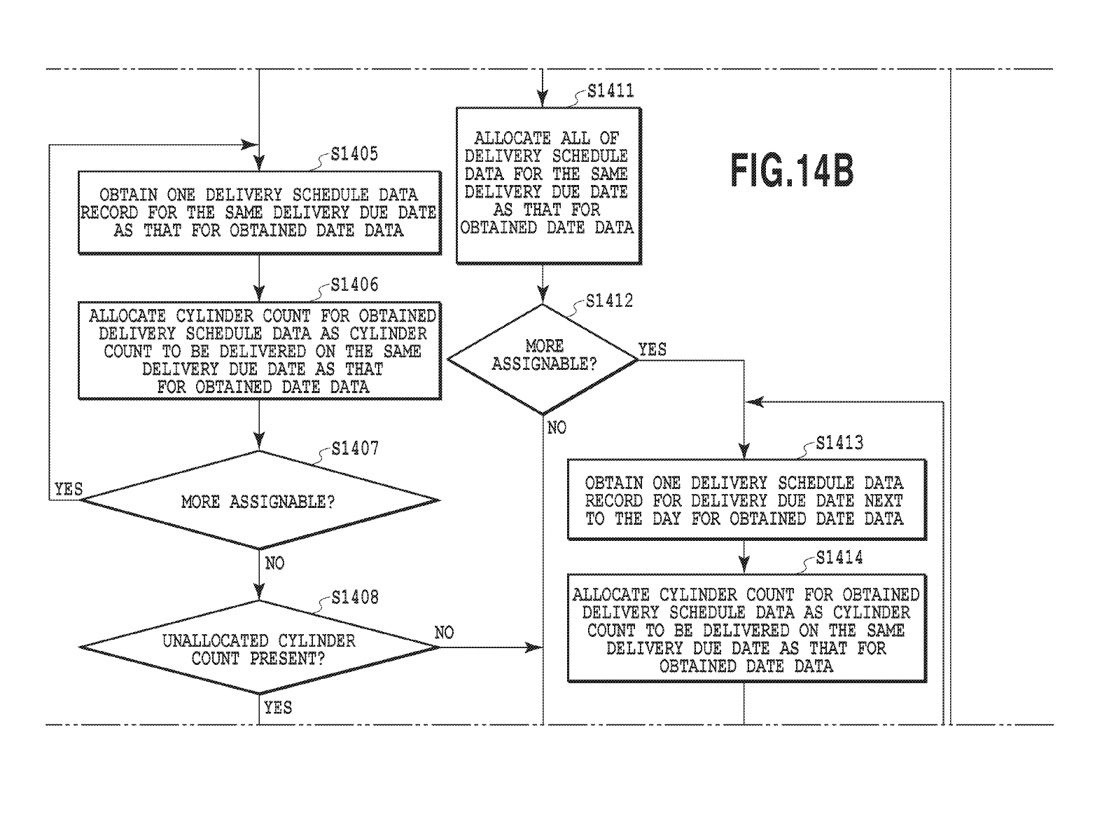

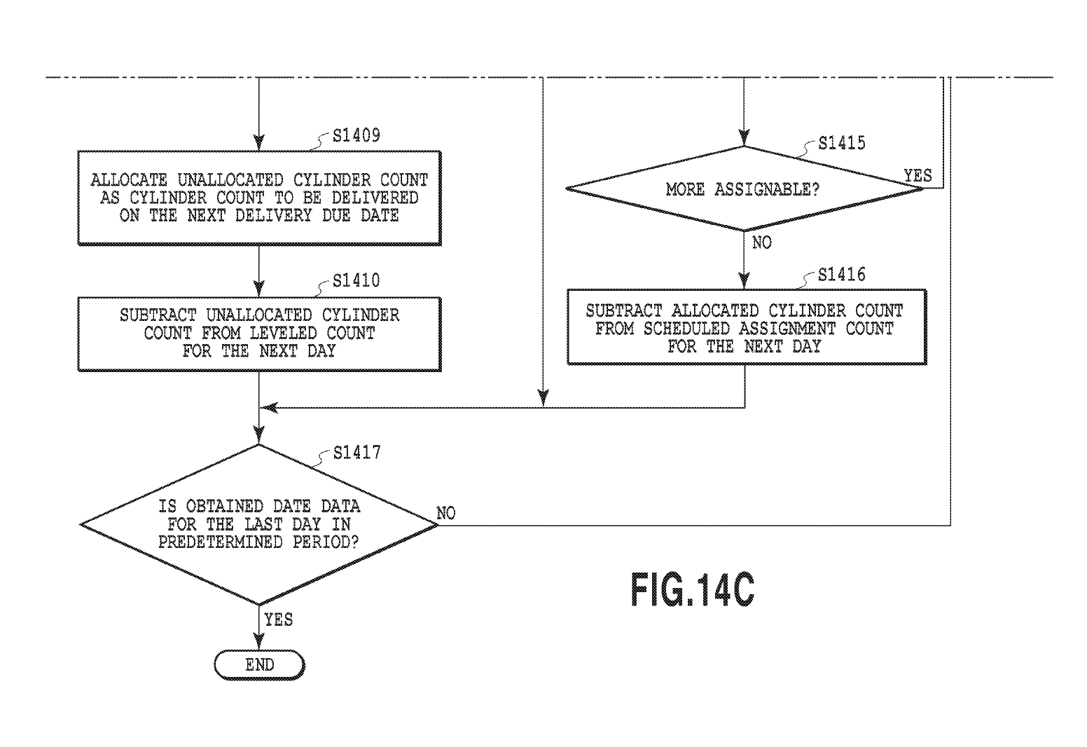

The leveled count for each day in the predetermined period has been obtained by performing the above processing. Next, the delivery schedule assignment unit 216 coordinates the delivery due date by allocating the scheduled delivery count in accordance with the leveled count for each day. The delivery schedule assignment processing related to one embodiment will now be described in detail while referring to the flowcharts in FIGS. 14A to 14C.

First, the delivery schedule assignment unit 216 sorts the delivery schedule data extracted at step 801 in accordance with the priorities of the delivery due dates (ascending order) and the delivery intervals (ascending order) that are gas shortage risk coefficients (step 1401). This sorting processing is performed while excluding delivery schedule data related to the leveling exception data. The delivery interval is obtained by calculating equation 3 below.

(Gas cylinder capacity*vaporization rate)/predicted calculation standard Equation 3

The gas cylinder capacity in equation 3 is, for example, the “capacity” in FIG. 3 described above. The vaporization rate is the rate of conversion into a volume (m³) in a case wherein liquefied LP gas (the unit amount is kg) is vaporized. This rate varies depending on the temperature. The predicted calculation standard is the predicted usage average for each day that is obtained by dividing, by the number of days following a starting point, the predicted usage (m³) after a specific day as the starting point. Here, the predicted usage is a value acquired in advance based on the actual usage obtained by monthly meter reading operation. Therefore, the delivery interval indicates the number of days predicted until the amount of LP gas in the gas cylinder is exhausted (gas shortage occurs). Thus, when the value of the delivery interval is small, the risk for the occurrence of gas shortage is high, and the priority for the delivery is increased.

Further, the sorting result at this step (the arrangement order) is employed as the priority order for assigning the delivery schedule data. In another embodiment, the delivery schedule assignment unit 216 may also change a priority parameter of, for example, the delivery due date (ascending order) to another item, or may add a new item to this parameter to sort the delivery schedule data.

Next, the delivery schedule assignment unit 216 calculates the scheduled assignment count for each day in the predetermined period (step 1402). The scheduled assignment count is originally the cylinder count, for which delivery schedule data is assigned to an arbitrary day in the predetermined period. The scheduled assignment count is obtained by calculating equation 4 below.

Scheduled delivery count−leveling exception count Equation 4

The scheduled delivery count in equation 4 is obtained by adding up the (scheduled delivery) cylinder counts for the individual delivery due dates that are included in the delivery schedule data extracted at step 801.

Subsequently, the delivery schedule assignment unit 216 obtains date data for the first day in the predetermined period (step 1403). Then, the delivery schedule assignment unit 216 compares the leveled count for the first date in the predetermined period with the scheduled assignment count (step 1404). This is performed in order to determine whether the scheduled assignment count falls within the leveled count, and when the scheduled assignment count does not fall within the leveled count, the delivery schedule assignment unit 216 performs the assignment processing in accordance with the priority order employed at step 1401, and allots the surplus to the delivery for the following day.

In a case wherein the scheduled assignment count is greater than the leveled count, the delivery schedule assignment unit 216 obtains, for one record, delivery schedule data for the same delivery due date as that for the obtained date data (step 1405). At this time, the obtained record is based on the sorting order employed at step 1401. As a result, the priority order for the assignment processing to be described in detail below is determined.

Next, the delivery schedule assignment unit 216 allocates the (scheduled delivery) cylinder count included in the obtained delivery schedule data as the delivery count for the same delivery due date as that for the obtained date data (step 1406). The “allocating” or the “assignment processing” includes updating of the delivery due date based on the obtained date data. It should be noted, however, that the delivery due date need not be updated in a case wherein the delivery due date to be updated is the same date as the original delivery due date. Further, the scheduled delivery count to be allocated is not always one cylinder. Therefore, even when the scheduled delivery count is two cylinders and the remaining cylinder count to be allocated for the leveled count is only one cylinder, the scheduled delivery count of two cylinders can be allocated. This is to avoid an inefficient operation in which delivery of gas cylinders for the same customer (destination) is purposely made multiple times.

Following this, the delivery schedule assignment unit 216 determines whether the cylinder count to be allocated for the leveled count remains, and whether the assignment processing can be continued (step 1407). This determination processing can be performed by counting scheduled delivery count that has been assigned, and comparing this counted scheduled delivery count with the leveled count.

In a case wherein the assignment processing can be continued, the delivery schedule assignment unit 216 repeats the assignment processing (step 1405 to 1407). In a case wherein the assignment processing cannot be continued, the delivery schedule assignment unit 216 determines whether data for which the assignment processing is not yet performed (hereinafter referred to as unallocated data) is still included in the delivery schedule data for the same delivery due date as that for the obtained date data (step 1408).

In a case wherein there are no unallocated data, the delivery schedule assignment processing advances to step 1417. In a case wherein there are unallocated data, the delivery schedule assignment unit 216 preferentially allocates the unallocated data as delivery count for the next delivery due date, the scheduled delivery count for the unallocated data (i.e., relative to the leveled count for the next day) (step 1409). As well as the assignment processing at steps 1405 to 1407, this assignment processing can also be performed in the sorting order employed at step 1401. However, in a case wherein there is the scheduled delivery count for the unallocated data beyond the leveled count for the next day, the delivery schedule assignment unit 216 performs the assignment processing for the leveled count for the day after next. The delivery schedule assignment unit 216 repeats this processing until allocating of the scheduled delivery count for the unallocated data is completed. However, since such a case rarely occurs, and the process is complicated, the process is not shown in the charts.

Since the unallocated data is allocated at step 1409 for the leveled count for the next day, the delivery schedule assignment unit 216 subtracts the cylinder counts for the unallocated data from the leveled count for the next day (step 1410). After this step, the delivery schedule assignment processing moves to step 1417.

In a case wherein the scheduled assignment count falls within the leveled count at step 1404, the delivery schedule assignment unit 216 allocates all of the delivery schedule data for the same delivery due date as that for the obtained date data (step 1411). As well as the assignment processing at steps 1405 to 1407, this assignment processing can be performed in the sorting order employed at step 1401. However, since the assignment processing is eventually performed for all of the delivery schedule data for the same delivery due date as that for the obtained date data, the order for the processing can be disregarded.

Thereafter, the delivery schedule assignment unit 216 determines whether the cylinder count to be allocated for the leveled count remains, and whether the assignment processing can be continued (step 1412). In a case wherein the assignment processing cannot be continued, i.e., wherein the scheduled assignment count is equal to the leveled count, the delivery schedule assignment processing moves to step 1417.

On the contrary, in a case wherein the assignment processing can be continued, i.e., in a case wherein the scheduled assignment count is smaller than the leveled count, the delivery schedule assignment unit 216 can allocate the delivery schedule data of the next day, ahead of schedule. In this case, the delivery schedule assignment unit 216 obtains, for one record, the delivery schedule data for the delivery due date that follows the day for the obtained date data (step 1413). Then, the delivery schedule assignment unit 216 allocates the (delivery scheduled) cylinder count for the obtained delivery schedule data for the next day, as the delivery count for the same delivery due date as that for the obtained date data (step 1413).

Subsequently, the delivery schedule assignment unit 216 determines whether the cylinder count to be allocated for the leveled count remains, and whether the assignment processing can be continued (step 1415). In a case wherein the assignment processing can be continued, the delivery schedule assignment unit 216 repeats the assignment processing (steps 1413 to 1415). In a case wherein the assignment processing cannot be continued, since the scheduled assignment count for the delivery schedule data has been allocated at step 1414, the delivery schedule assignment unit 216 subtracts the allocated cylinder count from the scheduled assignment count for the next day (step 1416). The allocated cylinder count is the total of the scheduled delivery counts, for which the assignment processing has been performed at step 1414. After this step, the schedule delivery assignment processing advances to step 1417.

At step 1417, the delivery schedule assignment unit 216 determines whether the obtained date data (i.e., data for the closest date, for which the assignment processing was performed) is for the last day in the predetermined period. In a case wherein the obtained date data is not for the last day (i.e., a case wherein data to be processed still remains), the delivery schedule assignment unit 216 obtains the next date data in the predetermined period (step 1418). The delivery schedule assignment unit 216 repeats steps 1404 to 1417 until the delivery schedule data for the last day in the predetermined period is reached. As a result, the assignment processing can be performed for all of the delivery schedule data for the first day to the last day in the predetermined period. It should be noted that, in a case wherein the obtained date data is for the last day in the predetermined period at step 1417, the delivery schedule assignment processing is terminated.

1. A method implemented by one or more computers for replacing a scheduled delivery count of each day in a predetermined period, the one or more computers comprising:
one or more processors; and
one or more memories coupled to the one or more processors, the one or more memories storing:
deliveryman data including a deliveryman ID, a rank representing the number of a gas cylinder deliverable by a deliveryman in one day, and a delivery base code representing a delivery base at which the deliveryman works;
delivery schedule data including a customer ID, a delivery due date, the scheduled delivery count representing the number of the gas cylinder to be delivered, and the delivery base code; and
leave data including the deliveryman ID, and a leave schedule for the deliverymen,
the method comprising:
obtaining, by the one or more processors, from the delivery man data, the deliveryman ID and the rank which are associated with the delivery base code predetermined;
obtaining, by the one or more processors, from the delivery schedule data, the scheduled delivery count which is associated with the predetermined delivery base code and for which the delivery due date is within the predetermined period;
obtaining, by the one or more processors, from the leave data, the leave schedule associated the obtained deliveryman ID;
deriving, by the one or more processors, a deliverable count of each day in the predetermined period by adding up the obtained rank based on the obtained leave schedule, the deliverable count being derived after excepting the obtained rank associated with the deliveryman ID of the leave data for which the obtained leave schedule is each day in the predetermined period;
deriving, by the one or more processors, a total deliverable count by adding up the deliverable count of each day in the predetermined period;
deriving, by the one or more processors, a total scheduled delivery count by adding up the obtained scheduled delivery count; and
replacing, by the one or more processors, the obtained scheduled delivery count of each day in the predetermined period with a leveled count of each day in the predetermined period by multiplying the total scheduled delivery count by a ratio deliverable in each day in the predetermined period, the ratio being derived by dividing the deliverable count by the total deliverable count.

2. The method according to claim 1, wherein the delivery schedule data further includes a capacity and a delivery interval of the gas cylinder, the interval being derived by multiplying the capacity by a vaporization rate and dividing it by predicted calculation standard, the vaporization rate being a rate of conversion into a volume in a case wherein gas is vaporized, the predicted calculation standard being a predicted usage average for each day derived based on an actual usage for each customer,
the method further comprising:
sorting, by the one or more processors, the delivery schedule data which is associated with the predetermined delivery base code and for which the delivery due date is within the predetermined period in ascending order of the delivery interval; and
updating, by the one or more processors, the sorted delivery schedule data by updating the delivery due date in the sorted delivery schedule data based on the leveled count of each day in the predetermined period and the scheduled delivery count in the sorted delivery schedule data.

3. The method according to claim 2, wherein the one or more memories further stores leveling exception data including an exception customer ID excluded from a leveling processing,
the method further comprising:
obtaining, by the one or more processors, from the leveling exception data, the exception customer ID;
deriving, by the one or more processors, a leveling exception count of each day in the predetermined period by adding up the scheduled delivery count of each day in the predetermined period which is associated with the customer ID matching the obtained exception customer ID; and
deriving, by the one or more processors, a second leveled count of each day in the predetermined period by subtracting the leveling exception count of each day in the predetermined period from the leveled count of each day in the predetermined period,
wherein the sorting the delivery schedule data is performed after excepting the delivery schedule data associated with the customer ID matching the obtained exception customer ID, and
wherein the updating the sorted delivery schedule data is performed based on the second leveled count of each day in the predetermined period and the scheduled delivery count in the sorted delivery schedule data.

4. A non-transitory computer-readable storage medium having computer-executable instructions which cause one or more computers to perform a method for replacing a scheduled delivery count of each day in a predetermined period, the one or more computers comprising:
one or more processors; and
one or more memories coupled to the one or more processors, the one or more memories storing:
deliveryman data including a deliveryman ID, a rank representing the number of a gas cylinder deliverable by a deliveryman in one day, and a delivery base code representing a delivery base at which the deliveryman works;
delivery schedule data including a customer ID, a delivery due date, the scheduled delivery count representing the number of the gas cylinder to be delivered, and the delivery base code; and
leave data including the deliveryman ID, and a leave schedule for the deliverymen,
the method comprising:
obtaining, by the one or more processors, from the delivery man data, the deliveryman ID and the rank which are associated with the delivery base code predetermined;
obtaining, by the one or more processors, from the delivery schedule data, the scheduled delivery count which is associated with the predetermined delivery base code and for which the delivery due date is within the predetermined period;
obtaining, by the one or more processors, from the leave data, the leave schedule associated the obtained deliveryman ID;
deriving, by the one or more processors, a deliverable count of each day in the predetermined period by adding up the obtained rank based on the obtained leave schedule, the deliverable count being derived after excepting the obtained rank associated with the deliveryman ID of the leave data for which the obtained leave schedule is each day in the predetermined period;
deriving, by the one or more processors, a total deliverable count by adding up the deliverable count of each day in the predetermined period;
deriving, by the one or more processors, a total scheduled delivery count by adding up the obtained scheduled delivery count; and
replacing, by the one or more processors, the obtained scheduled delivery count of each day in the predetermined period with a leveled count of each day in the predetermined period by multiplying the total scheduled delivery count by a ratio deliverable in each day in the predetermined period, the ratio being derived by dividing the deliverable count by the total deliverable count.

5. One or more computer for replacing a scheduled delivery count of each day in a predetermined period, comprising:
one or more processors; and
one or more memories coupled to the one or more processors, the one or more memories storing:
deliveryman data including a deliveryman ID, a rank representing the number of a gas cylinder deliverable by a deliveryman in one day, and a delivery base code representing a delivery base at which the deliveryman works;
delivery schedule data including a customer ID, a delivery due date, the scheduled delivery count representing the number of the gas cylinder to be delivered, and the delivery base code; and
leave data including the deliveryman ID, and a leave schedule for the deliverymen,
the one or more processors being configured to:
obtain, from the delivery man data, the deliveryman ID and the rank which are associated with the delivery base code predetermined;
obtain, from the delivery schedule data, the scheduled delivery count which is associated with the predetermined delivery base code and for which the delivery due date is within the predetermined period;
obtain, from the leave data, the leave schedule associated the obtained deliveryman ID;
derive a deliverable count of each day in the predetermined period by adding up the obtained rank based on the obtained leave schedule, the deliverable count being derived after excepting the obtained rank associated with the deliveryman ID of the leave data for which the obtained leave schedule is each day in the predetermined period;
derive a total deliverable count by adding up the deliverable count of each day in the predetermined period;
derive a total scheduled delivery count by adding up the obtained scheduled delivery count; and
replace the obtained scheduled delivery count of each day in the predetermined period with a leveled count of each day in the predetermined period by multiplying the total scheduled delivery count by a ratio deliverable in each day in the predetermined period, the ratio being derived by dividing the deliverable count by the total deliverable count.
